(19) United States
(12) Patent Application Publication
(10) Pub. No.: US 2022/0116359 A1
(43) Pub. Date: Apr. 14, 2022

(54) METHOD, DEVICE, AND COMPUTER-READABLE STORAGE MEDIUM FOR PROCESSING AN ACCESS REQUEST

(71) Applicant: Tsinghua University, Beijing (CN)

(72) Inventors: Xing Li, Beijing (CN); Congxiao Bao, Beijing (CN)

(73) Assignee: Tsinghua University, Beijing (CN)

(21) Appl. No.: 17/172,637

(22) Filed: Feb. 10, 2021

(30) Foreign Application Priority Data
Oct. 12, 2020 (CN) 202011087029X

(51) Int. Cl. H04L 29/06; H04L 29/12

(52) U.S. Cl. CPC H04L 63/0236; H04L 61/2007; H04L 63/101

(57) ABSTRACT

Methods, devices, and a non-transitory computer-readable storage mediums for processing an access request. The method includes receiving the access request and generating a suffix of a first IPv6 address corresponding to the access request according to a predetermined algorithm based on a uniform resource locator of a resource requested to be accessed. The method also includes viewing a suffix of a second IPv6 address in an access process corresponding to the access request and comparing the suffix of the first IPv6 address with the suffix of the second IPv6 address. The method further includes judging whether the access request is legal based on the comparison result.

### CROSS-REFERENCE TO RELATED APPLICATIONS

The present application claims priority to Chinese Patent Application No. 202011087029X filed on Oct. 12, 2020, entitled “Method, Device and Readable Storage Medium for Processing Access Request,” the disclosure of which is hereby incorporated by reference in its entirety.

### BACKGROUND

Uniform resource locator (URL) is a standard way of locating Internet resource addresses. A resource can be uniquely identified on the Internet through a uniform resource locator. In the network, the uniform resource locator belongs to application layer information. In order to protect user privacy, encryption protocols (such as HTTPs) are increasingly used to make the uniform resource locator invisible to network managers, and thus the network managers fail to legally supervise users who access the network. Therefore, the privacy and visibility of the uniform resource locator are in contradiction with the management requirements of the network, and how to ensure the effective operation of network management while protecting user privacy is a problem to be solved urgently.

### SUMMARY

In order to solve at least the aforementioned technical problems mentioned above, embodiments of the present application provide a method, a device, and a readable storage medium for, among other things, processing an access request.

The present application provides a method for processing an access request. The method includes receiving the access request and generating a suffix of a first IPv6 address corresponding to the access request according to a predetermined algorithm based on a uniform resource locator of a resource requested to be accessed. The method also includes viewing a suffix of a second IPv6 address in an access process corresponding to the access request. The method further includes comparing the suffix of the first IPv6 address with the suffix of the second IPv6 address. The method also includes judging whether the access request is legal based on the comparison result.

In some embodiments, the predetermined algorithm is a one-way function being an irreversible arbitrary function.

In some embodiments, judging whether the access request is legal based on the comparison result further includes judging whether the access request is legal based on the uniform resource locator, the suffix of the first IPv6 address, a plurality of pre-stored legal uniform resource locators, and suffixes of a plurality of legal IPv6 addresses corresponding to the plurality of pre-stored legal uniform resource locators when the suffix of the first IPv6 address is the same as the suffix of the second IPv6 address. The judging further includes determining the access request is illegal when the suffix of the first IPv6 address is different from the suffix of the second IPv6 address.

In some embodiments, judging whether the access request is legal based on the uniform resource locator, the suffix of the first IPv6 address, the plurality of pre-stored legal uniform resource locators, and the suffixes of the plurality of various legal IPv6 addresses corresponding to the plurality of pre-stored legal uniform resource locators further includes traversing the plurality of pre-stored legal uniform resource locators and the suffixes of the plurality of legal IPv6 addresses corresponding to the plurality of pre-stored legal uniform resource locators based on the uniform resource locator and the suffix of the first IPv6 address. The judging also includes determining that the access request is legal when a consistent uniform resource locator and an IPv6 address suffix are searched out among the various pre-stored legal uniform resource locators and legal IPv6 addresses corresponding to the various legal uniform resource locators. The judging further includes determining that the access request is illegal when the consistent uniform resource locator and the IPv6 address suffix are not searched out among the plurality of pre-stored legal uniform resource locators and the plurality of legal IPv6 addresses corresponding to the plurality of pre-stored legal uniform resource locators.

In some embodiments, a prefix of the IPv6 address is pre-configured, and the IPv6 address includes the prefix and the suffix.

The present application also provides a device for processing an access request. The device includes, for example, a receiver, a viewer, and a judger. The receiver is configured to receive the access request and generate a suffix of a first IPv6 address corresponding to the access request according to a predetermined algorithm based on a uniform resource locator of a resource requested to be accessed. The viewer is configured to view a suffix of a second IPv6 address in an access process corresponding to the access request. The judger is configured to compare the suffix of the first IPv6 address with the suffix of the second IPv6 address and judge whether the access request is legal based on the comparison result.

In some embodiments, to judge whether the access request is legal based on the comparison result, the judger is further configured to judge whether the access request is legal based on the uniform resource locator, the suffix of the first IPv6 address, a plurality of pre-stored legal uniform resource locators, and suffixes of a plurality of legal IPv6 addresses corresponding to the plurality of pre-stored legal uniform resource locators when the suffix of the first IPv6 address is the same as the suffix of the second IPv6 address. The judger is also configured to determine the access request is illegal when the suffix of the first IPv6 address is different from the suffix of the second IPv6 address.

In some embodiments, to judge whether the access request is legal based on the uniform resource locator, the suffix of the first IPv6 address, the plurality of pre-stored legal uniform resource locators, and the suffixes of the plurality of legal IPv6 addresses corresponding to the plurality of pre-stored legal uniform resource locators, the judger is further configured to traverse the plurality of pre-stored legal uniform resource locators and the suffixes of the plurality of legal IPv6 addresses corresponding to the plurality of pre-stored legal uniform resource locators based on the uniform resource locator and the suffix of the first IPv6 address. The judger is also configured to determine that the access request is legal when a consistent uniform resource locator and an IPv6 address suffix are searched out among the plurality of pre-stored legal uniform resource locators and the plurality of legal IPv6 addresses corresponding to the plurality of pre-stored legal uniform resource locators. The judger is further configured to determine that the access request is illegal when the consistent uniform resource locator and the IPv6 address suffix are not searched out among the plurality of pre-stored legal uniform resource locators and the plurality of legal IPv6 addresses corresponding to the plurality of pre-stored legal uniform resource locators.

The present application further provides an electronic device including, for example, a memory, a processor, and computer programs. The computer programs are stored in the memory and executable on the processor. The processor is configured to implement steps of any one of the methods for processing the access request mentioned above when executing the computer programs.

The present application also provides a non-transitory computer-readable storage medium on which computer programs are stored. The computer programs are executed by a processor to implement steps of any one of the methods for processing the access request mentioned above.

IPv6, as a network layer protocol, has addresses that are transparent to network managers. The network managers may control the transmission of network resources through the IPv6 addresses without contacting the uniform resource locator or other application layer content, which can ensure the effective operation of network management while protecting user privacy.

### BRIEF DESCRIPTION OF THE DRAWINGS

In order to more clearly illustrate the technical solutions disclosed in certain embodiments of the present application, drawings aiding in the descriptions of the embodiments are be briefly introduced below. Obviously, the drawings in the following description are only based on some of the embodiments of the present application, and other drawings can be obtained according to these drawings without any creative effort for those skilled in the art.

FIG. 1 is a schematic flowchart of a method for processing an access request according to an exemplary embodiment of the present application;

FIG. 2 is a schematic structural diagram of a device for processing an access request according to an exemplary embodiment of the present application; and

FIG. 3 is a schematic structural diagram of an electronic apparatus according to an exemplary embodiment of the present application.

### DETAILED DESCRIPTION

In order to make the objectives, technical solutions and advantages of the embodiments of the present application clearer, the technical solutions in certain embodiments of the present application will be described clearly and completely in conjunction with the accompanying drawings. Obviously, the described embodiments are part of the embodiments of the present application, rather than all of the embodiments. All other embodiments obtained by a person of ordinary skill in the art based on the disclosure of the present application without any creative effort fall within the protection scope of the present application.

Currently, the privacy and visibility of the uniform resource locator are in a contradiction with the management requirements of the network, and how to ensure the effective operation of network management while protecting user privacy is a problem to be solved.

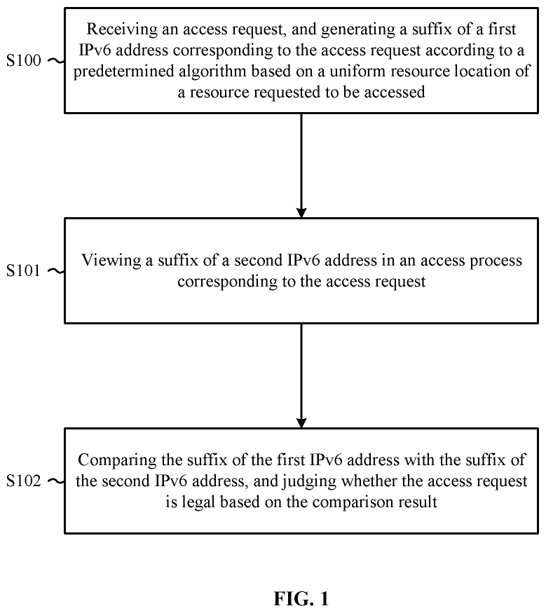

In this regard, an embodiment of the present application provides a method for processing an access request. FIG. 1 is a schematic flowchart of a method for processing an access request according to an exemplary embodiment of the present application. As shown in FIG. 1, the method includes the following steps.

In a step S100, receiving an access request, and generating a suffix of a first IPv6 address corresponding to the access request according to a predetermined algorithm based on a uniform resource locator of a resource requested to be accessed.

In an embodiment, when a server receives an access request initiated by a user terminal, the server generates the suffix of the first IPv6 address corresponding to the access request according to the predetermined algorithm based on the uniform resource locator of the resource requested to be accessed by the user terminal.

In a step S101, viewing a suffix of a second IPv6 address in an access process corresponding to the access request.

In an exemplary embodiment, the server views the suffix of the second IPv6 address in the access process corresponding to the access request based on the received access request initiated by the user terminal. Wherein, the method used by the server to specifically view the suffix of the second IPv6 address in the access process corresponding to the access request may be any method, on which there is no specific restriction in the embodiment of the present application.

In a step S102, comparing the suffix of the first IPv6 address with the suffix of the second IPv6 address, and judging whether the access request is legal based on the comparison result.

In an exemplary embodiment, the server compares the suffix of the first IPv6 address with the suffix of the second IPv6 address, and judges whether the access request is legal based on the comparison result.

In the method according to the embodiments of the present application, the transmission of network resources is controlled through IPv6 addresses, so that the network manager may ensure the effective operation of network management without contacting the uniform resource locator or other application layer content, and the contradiction between the needs of network managers and the protection of user privacy is resolved, which may ensure the effective operation of network management while protecting user privacy.

Based on the foregoing embodiments, the predetermined algorithm is a one-way function being an irreversible arbitrary function.

For example, a unique IPv6 address suffix 2c4d:88e7:0388:9a4b is generated based on the uniform resource locator through a one-way function. The prefix of the IPv6 address of the server is combined with the suffix of the IPv6 address to form the address 2001:da8:cccc:cccc:2c4d:88e7:0388:9a4b.

In an embodiment, the one-way function may be any irreversible function, such as a hash function, which is not limited in the embodiment of the present application.

In the method according to the embodiment of the present application, whether the access request is legal is judged based on the suffix of the IPv6 address corresponding to the access request generated by the one-way function and various pre-stored legal IPv6 addresses, so that the network managers may ensure the effective operation of network management without contacting the uniform resource locator or other application layer content, and the needs of network managers and the user privacy are taken into account.

Based on the foregoing embodiments, the step S102, i.e., the comparing the suffix of the first IPv6 address with the suffix of the second IPv6 address, and judging whether the access request is legal based on the comparison result, includes: judging whether the access request is legal based on the uniform resource locator, the suffix of the first IPv6 address, and the various pre-stored legal uniform resource locators and suffixes of various legal IPv6 addresses corresponding to the various legal uniform resource locators when the suffix of the first IPv6 address is the same as the suffix of the second IPv6 address; and determining the access request is illegal when the suffix of the first IPv6 address is different from the suffix of the second IPv6 address.

In an exemplary embodiment, the server compares the suffix of the first IPv6 address with the suffix of the second IPv6 address, and further judges whether the access request is legal based on the uniform resource locator, the suffix of the first IPv6 address, and the various pre-stored legal uniform resource locators and the suffixes of the various legal IPv6 addresses corresponding to the various legal uniform resource locators when the suffix of the first IPv6 address is the same as the suffix of the second IPv6 address; and determines the access request is illegal when the suffix of the first IPv6 address is different from the suffix of the second IPv6 address, i.e., the suffix of the first IPv6 address corresponding to the access request generated according to a predetermined algorithm based on the uniform resource locator of the resource requested to be accessed is different from the suffix of the second IPv6 address in the access process corresponding to the access request viewed by the server, which means that the current access request may be an access initiated by a malicious user through the illegally tampered uniform resource locator to make an attempt to access the resource through the illegally tampered uniform resource locator.

For example, the server has 10 resources. Based on security considerations, only access to a first resource is open to users, that is, the users only have access to the first resource. When a malicious user attempts to access a second resource illegally through illegally tampering with the access address of the first resource based on the access address of the first resource, the server receives an access request to the second resource and generates the suffix of the first IPv6 address corresponding to the access request based on the uniform resource locator of the resource requested to be accessed; at the same time, the server views the suffix of the second IPv6 address in the access process corresponding to the access request. Since the access process corresponding to the access request is accessing the first resource, the suffix of the first IPv6 address and the suffix of the second IPv6 address is necessarily different, it means that the current access request may be an access initiated by a malicious user through the illegally tampered uniform resource locator to make an attempt to access the resource through the illegally tampered uniform resource locator, and thus the access request is determined to be illegal.

In the method according to the embodiments of the present application, the transmission of network resources is controlled through IPv6 addresses, and the access request is determined to be illegal when the suffix of the first IPv6 address corresponding to the access request generated according to a predetermined algorithm based on the uniform resource locator of the resource requested to be accessed is different from the suffix of the second IPv6 address in the access process corresponding to the access request viewed by the server, so that the network manager may ensure the effective operation of the network management without contacting the uniform resource locator or other application layer content, and the contradiction between the needs of network managers and the protection of user privacy is resolved, which may ensure the effective operation of network management while protecting user privacy.

Based on the foregoing embodiments, the judging whether the access request is legal based on the uniform resource locator, the suffix of the first IPv6 address, and the various pre-stored legal uniform resource locators and the suffixes of various legal IPv6 addresses corresponding to the various legal uniform resource locators includes: traversing the various pre-stored legal uniform resource locators and the suffixes of the various legal IPv6 addresses corresponding to the various legal uniform resource locators based on the uniform resource locator and the suffix of the first IPv6 address, and determining that the access request is legal when a consistent uniform resource locator and an IPv6 address suffix are searched out among the various pre-stored legal uniform resource locators and the legal IPv6 addresses corresponding to the various legal uniform resource locators; and determining that the access request is illegal when no consistent uniform resource locator and IPv6 address suffix are searched out among the various pre-stored legal uniform resource locators and the legal IPv6 addresses corresponding to the various legal uniform resource locators.

In an exemplary embodiment, a plurality of legal uniform resource locators and a plurality of legal IPv6 addresses are pre-stored in the server, the plurality of legal IPv6 addresses are generated based on the uniform resource locator of each resource capable of providing access services in the server. The server traverses each pre-stored legal uniform resource locator and the suffix of each legal IPv6 address corresponding to each legal uniform resource locator based on the uniform resource locator and the suffix of the first IPv6 address corresponding to the access request, and determines that the access request is legal when a consistent uniform resource locator and an IPv6 address suffix are searched out among the various pre-stored legal uniform resource locators and the legal IPv6 addresses corresponding to the various legal uniform resource locators, which means that the IPv6 address requested to access by the current user terminal is one of the plurality of legal IPv6 addresses pre-stored in the server, and the server may provide access services for the current user terminal, that is, the server determines that the access request of the current user terminal is legal. Further, since the plurality of legal IPv6 addresses are generated based on the uniform resource locator of each resource capable of providing access services in the server, it means that the server may provide the current user terminal with access services for the resource corresponding to the uniform resource locator when the IPv6 address requested by the current user terminal is one of the plurality of legal IPv6 addresses pre-stored in the server. Correspondingly, the server determines that the access request of the current user terminal is illegal when no consistent uniform resource locator and IPv6 address suffix are searched out among the various pre-stored legal uniform resource locators and the legal IPv6 addresses corresponding to the various legal uniform resource locators, which means that the IPv6 address requested by the current user terminal is different from the plurality of legal IPv6 addresses pre-stored in the server. Further, since the plurality of legal IPv6 addresses are generated based on the uniform resource locators of respective resources capable of providing access services in the servers, it means that there is no resource corresponding to the uniform resource locator that the current user terminal requests to access in the server when the IPv6 address requested to be accessed by the current user terminal is different from the plurality of legal IPv6 addresses pre-stored in the server, that is, the server cannot provide the current user terminal with access service to the resource corresponding to the uniform resource locator, so the access request is determined to be illegal.

In the method according to the embodiments of the present application, whether the access request is legal is judged based on the uniform resource locator and the suffix of the first IPv6 address corresponding to the access request generated and various pre-stored legal IPv6 addresses, so that the network manager may ensure the effective operation of network management without contacting the uniform resource locator or other application layer content, and the needs of network managers and the user privacy are taken into account.

Based on the foregoing embodiments, a prefix of the IPv6 address is pre-configured, and the IPv6 address includes the prefix and the suffix.

In an exemplary embodiment, a segment of prefix of the IPv6 address is configured for the server, and related routing is configured for an uplink router of the server, so as to ensure that a data message can be delivered to the server as long as the destination address of the data message is under the prefix. The server monitors all addresses under the prefix of the IPv6 address, and process requests for all destination addresses under this prefix. Further, the IPv6 address includes the pre-configured prefix of the IPv6 address and the suffix of the IPv6 address corresponding to the access request generated based on the uniform resource locator of the resource requested to be accessed.

For example, the IPv6 global unicast prefix 2001:da8:cccc:cccc::/64 is configured for the server. Related routing is configured for an uplink router of the server, so as to ensure that a data message can be delivered to the server as long as the destination address of the data message is under the prefix. The server monitors all addresses under the prefix 2001:da8:cccc:cccc::/64 of the IPv6 address, and process requests for all destination addresses under this prefix.

In the method according to the embodiments of the present application, the prefix of the IPv6 address is pre-configured to ensure that a data message can be delivered to the server as long as the destination address of the data message is under the prefix, which further improves the reliability of network management.

Hereinafter, a specific example is used to further illustrate the method described in these embodiments.

The server contains a plurality of resources capable of providing access services. The suffixes of respective legal IPv6 addresses are generated based on the uniform resource locators of the plurality of resources capable of providing access services. Meanwhile, a segment of prefix 2001:da8:cccc:cccc::/64 of the IPv6 address is configured for the server; the prefix of the IPv6 address is combined with the suffixes of respective legal IPv6 addresses to form the plurality of legal IPv6 addresses, and the same is pre-stored in server. The server generates the suffix 2c4d:88e7:0388:9a4b of the legal IPv6 address in advance through a one-way function based on the URL of a certain resource capable of providing access services, combines the suffix of the IPv6 address with the pre-configured prefix of the IPv6 address to form the IPv6 address 2001:da8:cccc:cccc:2c4d:88e7:0388:9a4b, and pre-stores the above-mentioned legal IPv6 address generated in advance in the server. The server generates the suffix 2c4d:88e7:0388:8a3b of the legal IPv6 address in advance through a one-way function based on the URL of a certain resource capable of providing access services, combines the suffix of the IPv6 address with the pre-configured prefix of the IPv6 address to form the IPv6 address 2001:da8:cccc:cccc:2c4d:88e7:0388:8a3b, and pre-stores the above-mentioned legal IPv6 address generated in advance in the server.

When a user terminal initiates access to a first URL in the above-mentioned server, the server firstly generates the suffix of the first IPv6 address according to the URL requested by the user terminal through a one-way function after receiving an access request. At the same time, the server views the suffix of the second IPv6 address in an access process corresponding to the access request, compares the suffix of the first IPv6 address generated above with the viewed suffix of the second IPv6 address in the access process corresponding to the access request. Since the user enters a legal and authorized URL, the suffix of the first IPv6 address generated based on the URL is necessarily the same as the suffix of the second IPv6 address which is 2c4d:88e7:0388:9a4b, and the IPv6 address 2001:da8:cccc:cccc:2c4d:88e7:0388:9a4b, generated by combining with the prefix 2001:da8:cccc:cccc::/64 is a legal IPv6 address stored in the server, and thus services may be provided. Similarly, when the user terminal initiates access to a second URL in the above-mentioned server, the services may be provided according to the same process described above.

However, when a user terminal illegally accesses the server, the suffix 2c4d:88e7:0388:8a3b of the first IPv6 address generated by the URL is obviously different from the suffix 2c4d:88e7:0388:9a4b of the second IPv6 address. At this time, the server refuses to provide services.

Another situation is that when the user initiates access to a third URL that the server does not provide access to, a corresponding second IPv6 address is not pre-stored in the server although the suffix of the first IPv6 address generated by the URL and the suffix of the second IPv6 address is the same, so it is an illegal IP6 address and the server refuses to provide services.

Hereinafter, a device for processing an access request according to an exemplary embodiment of the present application is described. The device for processing the access request described below and the method for processing the access request described above may be referred to each other.

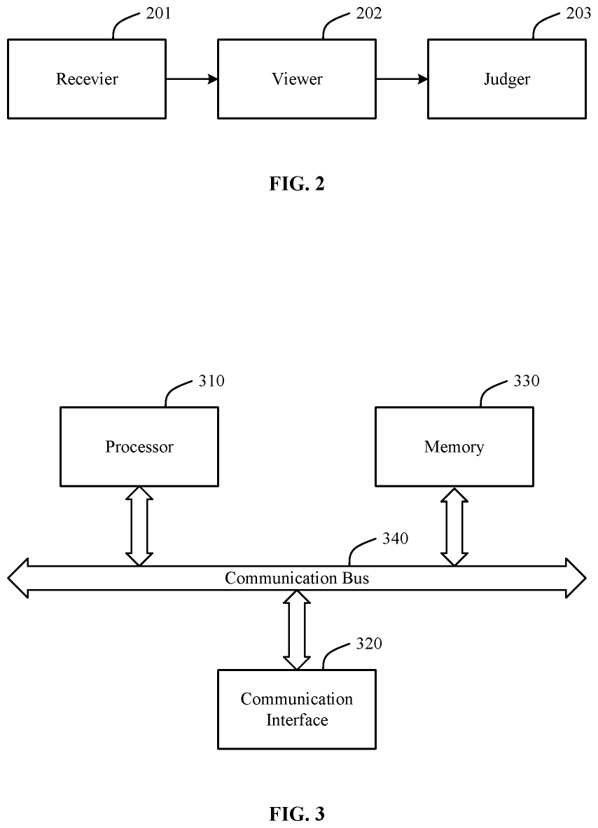

Based on any of the foregoing embodiments, FIG. 2 is a schematic structural diagram of a device for processing an access request according to an exemplary embodiment of the present application. As shown in FIG. 2, the device for processing the access request includes a receiver 201, a viewer 202, and a judger 203.

In an embodiment, the receiver 201 is configured to receive an access request, and generate a suffix of a first IPv6 address corresponding to the access request according to a predetermined algorithm based on a uniform resource locator of a resource requested to be accessed; the viewer 202 is configured to view a suffix of a second IPv6 address in an access process corresponding to the access request; and the judger 203 is configured to compare the suffix of the first IPv6 address with the suffix of the second IPv6 address, and judge whether the access request is legal based on the comparison result.

In the device according to an exemplary embodiment of the present application, the transmission of network resources is controlled through IPv6 addresses, so that the network manager may ensure the effective operation of network management without contacting the uniform resource locator or other application layer content, and the contradiction between the needs of network managers and the protection of user privacy is resolved, which may ensure the effective operation of network management while protecting user privacy.

Based on any of the foregoing embodiments, the comparing the suffix of the first IPv6 address with the suffix of the second IPv6 address, and judging whether the access request is legal based on the comparison result specifically includes: judging whether the access request is legal based on the uniform resource locator, the suffix of the first IPv6 address, and various pre-stored legal uniform resource locators and suffixes of various legal IPv6 addresses corresponding to the various legal uniform resource locators when the suffix of the first IPv6 address is the same as the suffix of the second IPv6 address; and determining the access request is illegal when the suffix of the first IPv6 address is different from the suffix of the second IPv6 address.

Based on any of the foregoing embodiments, the judging whether the access request is legal based on the uniform resource locator, the suffix of the first IPv6 address, and various pre-stored legal uniform resource locators and suffixes of various legal IPv6 addresses corresponding to the various legal uniform resource locators specifically includes: traversing the various pre-stored legal uniform resource locators and the suffixes of the various legal IPv6 addresses corresponding to the various legal uniform resource locators based on the uniform resource locator and the suffix of the first IPv6 address, and determining that the access request is legal when a consistent uniform resource locator and an IPv6 address suffix are searched out among the various pre-stored legal uniform resource locators and the legal IPv6 addresses corresponding to the various pre-stored legal uniform resource locators and the suffixes of the various legal uniform resource locators; and determining that the access request is illegal when no consistent uniform resource locator and IPv6 address suffix are searched out among the various pre-stored legal uniform resource locators and the legal IPv6 addresses corresponding to the various pre-stored legal uniform resource locators.

Based on any of the foregoing embodiments, a prefix of the IPv6 address is pre-configured, and the IPv6 address includes the prefix and the suffix.

Based on any of the foregoing embodiments, the suffix is generated based on the uniform resource locator through a one-way function.

The device for processing the access request in the embodiments of the present application can be configured to perform the technical solutions of the foregoing methods for processing the access request, and implementation principles and technical effects of the device are similar to those of the methods, and will not be repeated here.

FIG. 3 is a schematic diagram of the physical structure of an electronic device. As shown in FIG. 3, the electronic device may include a processor 310, a communication interface 320, a memory 330, and a communication bus 340. The processor 310, the communication interface 320, and the memory 330 communicate with each other through the communication bus 340. The processor 310 may call the logic instructions in the memory 330 to execute the steps according to the foregoing method embodiments.

In addition, the logic instructions in the memory 330 described above may be implemented in the form of a software functional unit and may be stored in a computer-readable storage medium while being sold or used as a separate product. Based on such understanding, the technical solutions of the present application or a part of the technical solutions may be embodied in the form of a software product, which is stored in a storage medium, including several instructions to cause a computer device (which may be a personal computer, server, or network device, etc.) to perform all or part of the steps of the methods described in various embodiments of the present application. The storage medium described above may include: a U disk, a mobile hard disk, a read-only memory (ROM), a random access memory (RAM), a magnetic disk or compact disk, and other media that can store program codes.

In another aspect, an embodiment of the present application also provides a non-transitory computer-readable storage medium on which computer programs are stored, and the computer programs are executed by a processor to perform the steps of the methods described in various embodiments of the present application.

The device embodiments described above are merely illustrative, wherein the units described as separate components may or may not be physically separate, and the components displayed as units may or may not be physical units, that is, may be located at the same place, or distributed to multiple network units. Some or all of the modules may be selected according to actual needs to achieve the purpose of the solutions of the embodiments. Those of ordinary skill in the art can understand and implement the embodiments described above without paying creative labors.

Through the description of the exemplary embodiments above, those skilled in the art can clearly understand that the various embodiments can be implemented by means of software and a hardware platform, and of course, by hardware. Based on such understanding, the technical solutions above or a part of the technical solutions may be embodied in the form of a software product, which is stored in a computer-readable storage medium such as ROM/RAM, magnetic disc, compact disc, etc., and includes several instructions to cause a computer device (which may be a personal computer, server, or network device, etc.) to perform the methods described in various embodiments or a part of the embodiments.

Finally, it should be noted that the above-described exemplary embodiments are only used to explain the technical solutions of the present application, rather than limiting them; although the present application is described in detail with reference to the foregoing embodiments, it should be understood by those skilled in the art that they can still modify the technical solutions described in the foregoing embodiments or make equivalent substitutions to a part of the technical features therein; these modifications or substitutions do not separate the essence of corresponding technical solutions from the spirit and scope of the technical solutions of the various embodiments of the present application.

1. A method for processing an access request, the method comprising:
receiving the access request;
generating a suffix of a first IPv6 address corresponding to the access request according to a predetermined algorithm based on a uniform resource locator of a resource requested to be accessed;
viewing a suffix of a second IPv6 address in an access process corresponding to the access request;
comparing the suffix of the first IPv6 address with the suffix of the second IPv6 address; and
judging whether the access request is legal based on the comparison result.

2. The method of claim 1, wherein the predetermined algorithm is a one-way function being an irreversible arbitrary function.

3. The method of claim 1, wherein judging whether the access request is legal based on the comparison result further comprises:
judging whether the access request is legal based on the uniform resource locator, the suffix of the first IPv6 address, a plurality of pre-stored legal uniform resource locators, and suffixes of a plurality of legal IPv6 addresses corresponding to the plurality of pre-stored legal uniform resource locators when the suffix of the first IPv6 address is the same as the suffix of the second IPv6 address, and
determining the access request is illegal when the suffix of the first IPv6 address is different from the suffix of the second IPv6 address.

4. The method of claim 3, wherein judging whether the access request is legal based on the uniform resource locator, the suffix of the first IPv6 address, the plurality of pre-stored legal uniform resource locators, and the suffixes of the plurality of legal IPv6 addresses corresponding to the plurality of pre-stored legal uniform resource locators further comprises:
traversing the plurality of pre-stored legal uniform resource locators and the suffixes of the plurality of legal IPv6 addresses corresponding to the plurality of pre-stored legal uniform resource locators based on the uniform resource locator and the suffix of the first IPv6 address;
determining that the access request is legal when a consistent uniform resource locator and an IPv6 address suffix are searched out among the plurality of pre-stored legal uniform resource locators and the plurality of legal IPv6 addresses corresponding to the plurality of pre-stored legal uniform resource locators; and
determining that the access request is illegal when the consistent uniform resource locator and the IPv6 address suffix are not searched out among the plurality of pre-stored legal uniform resource locators and the plurality of legal IPv6 addresses corresponding to the plurality of pre-stored legal uniform resource locators.

5. The method of claim 1, wherein a prefix of the first IPv6 address is pre-configured, and the first IPv6 address includes the prefix and the suffix.

6. A device for processing an access request, device comprising:
a receiver configured to receive the access request, and generate a suffix of a first IPv6 address corresponding to the access request according to a predetermined algorithm based on a uniform resource locator of a resource requested to be accessed;
a viewer configured to view a suffix of a second IPv6 address in an access process corresponding to the access request; and
a judger configured to compare the suffix of the first IPv6 address with the suffix of the second IPv6 address, and judge whether the access request is legal based on the comparison result.

7. The device of claim 6, wherein, to judge whether the access request is legal based on the comparison result, the judger is further configured to:
judge whether the access request is legal based on the uniform resource locator, the suffix of the first IPv6 address, a plurality of pre-stored legal uniform resource locators, and suffixes of a plurality of legal IPv6 addresses corresponding to the plurality of pre-stored legal uniform resource locators when the suffix of the first IPv6 address is the same as the suffix of the second IPv6 address; and
determine the access request is illegal when the suffix of the first IPv6 address is different from the suffix of the second IPv6 address.

8. The device of claim 7, wherein, to judge whether the access request is legal based on the uniform resource locator, the suffix of the first IPv6 address, the plurality of pre-stored legal uniform resource locators, and the suffixes of the plurality of legal IPv6 addresses corresponding to the plurality of pre-stored legal uniform resource locators, the judger is further configured to:
traverse the plurality of pre-stored legal uniform resource locators and the suffixes of the plurality of legal IPv6 addresses corresponding to the plurality of pre-stored legal uniform resource locators based on the uniform resource locator and the suffix of the first IPv6 address;
determine that the access request is legal when a consistent uniform resource locator and an IPv6 address suffix are searched out among the plurality of pre-stored legal uniform resource locators and the plurality of legal IPv6 addresses corresponding to the plurality of pre-stored legal uniform resource locators; and
determine that the access request is illegal when the consistent uniform resource locator and the IPv6 address suffix are not searched out among the plurality of pre-stored legal uniform resource locators and the plurality of legal IPv6 addresses corresponding to the plurality of pre-stored legal uniform resource locators.

9. The system of claim 6, wherein the predetermined algorithm is a one-way function being an irreversible arbitrary function.

10. The method of claim 6, wherein a prefix of the first IPv6 address is pre-configured, and the first IPv6 address includes the prefix and the suffix.

11. A non-transitory computer-readable storage medium, in which computer programs are stored, wherein the computer program, when executed by a processor, cause the processor to:
receive an access request;
generate a suffix of a first IPv6 address corresponding to the access request according to a predetermined algorithm based on a uniform resource locator of a resource requested to be accessed;
view a suffix of a second IPv6 address in an access process corresponding to the access request;
compare the suffix of the first IPv6 address with the suffix of the second IPv6 address, and
judge whether the access request is legal based on the comparison result.

12. The non-transitory computer-readable storage medium of claim 11, wherein the predetermined algorithm is a one-way function being an irreversible arbitrary function.

13. The non-transitory computer-readable storage medium of claim 11, wherein, to judge whether the access request is legal based on the comparison result, the computer instructions further cause the processor to:
judge whether the access request is legal based on the uniform resource locator, the suffix of the first IPv6 address, a plurality of pre-stored legal uniform resource locators, and suffixes of a plurality of legal IPv6 addresses corresponding to the plurality of pre-stored legal uniform resource locators when the suffix of the first IPv6 address is the same as the suffix of the second IPv6 address; and
determine the access request is illegal when the suffix of the first IPv6 address is different from the suffix of the second IPv6 address.

14. The non-transitory computer-readable storage medium of claim 13, wherein, to judge whether the access request is legal based on the uniform resource locator, the suffix of the first IPv6 address, the plurality of pre-stored legal uniform resource locators, and the suffixes of the plurality of legal IPv6 addresses corresponding to the plurality of pre-stored legal uniform resource locators, the computer program further causes the processor to:
traverse the plurality of pre-stored legal uniform resource locators and the suffixes of the plurality of legal IPv6 addresses corresponding to the plurality of pre-stored legal uniform resource locators based on the uniform resource locator and the suffix of the first IPv6 address;
determine that the access request is legal when a consistent uniform resource locator and an IPv6 address suffix are searched out among the plurality of pre-stored legal uniform resource locators and the plurality of legal IPv6 addresses corresponding to the plurality of pre-stored legal uniform resource locators; and
determine that the access request is illegal when the consistent uniform resource locator and the IPv6 address suffix are not searched out among the plurality of pre-stored legal uniform resource locators and the plurality of legal IPv6 addresses corresponding to the plurality of pre-stored legal uniform resource locators.

15. The non-transitory computer-readable storage medium of claim 11, wherein a prefix of the first IPv6 address is pre-configured, and the first IPv6 address includes the prefix and the suffix.
